(19) United States
(12) Patent Application Publication
(10) Pub. No.: US 2026/0298434 A1
(43) Pub. Date: Oct. 1, 2026

(54) VEHICLE LAMP

(71) Applicant: Stanley Electric Co., Ltd., Tokyo (JP)

(72) Inventor: Haruki IGAWA, Tokyo (JP)

(21) Appl. No.: 19/490,225

(22) PCT Filed: Jun. 5, 2024
(86) PCT No.: PCT/JP2024/020520

§ 371 Date: Dec. 4, 2025

(30) Foreign Application Priority Data
Jun. 7, 2023 (JP) 2023-093748

(51) Int. Cl. F21S 43/241; F21S 43/14; F21W 103/20

(52) U.S. Cl. CPC F21S 43/241; F21S 43/14; F21W 2103/20

(57) ABSTRACT

A vehicle lamp includes a light source and a light guide body configured to guide light emitted from the light source toward a side in front of the vehicle lamp. The light guide body includes a first-light-guide-portion having a semicircular shape centered on a light-emitting portion of the light source, and a second-light-guide-portion arranged at a position spaced apart from the first-light-guide-portion. The second-light-guide-portion is aligned and formed so that a semi-ring-shaped base portion and a plurality of light guide paths configured to project in a direction away from the base portion and having light-emitting portions in their distal end regions are formed and light-emitting portions are arrayed in a left-right direction in a spaced manner. The light-source-side side surface of the first-light-guide-portion converts light input into the light guide body from the light source into parallel light rays in a direction orthogonal to a first direction.

This application is a U.S. National Stage Application under 35 U.S.C § 371 of International Patent Application No. PCT/JP2024/020520 filed Jun. 5, 2024, which claims the benefit of priority under 35 U.S.C. § 119 to Japanese Patent Application No.

2023-093748 filed Jun. 7, 2023, the disclosures of all of which are hereby incorporated by reference in their entireties.

### TECHNICAL FIELD

The present invention relates to a vehicle lamp, for example, a lighting device or an indicator device used in a vehicle such as an automobile or a motorcycle.

Priority is claimed on Japanese Patent Application No. 2023-093748, filed Jun. 7, 2023, the content of which is incorporated herein by reference.

### BACKGROUND ART

Vehicle lamps configured so that a light-emitting diode (LED) is used as a light source to input light emitted from the LED into a light guide body and emit the light from a light emission surface of the light guide body to the front of the lamp are known. For example, an LED signal lamp of Patent Document 1 includes an LED mounted on a board and a plurality of plate-shaped light guide bodies arrayed in a direction orthogonal to an optical axis of the LED. An incident surface of each of the plurality of light guide bodies is an end surface of the plate-shaped light guide body and faces the LED. Technology in which the loss of an amount of light within the light guide body can be reduced by shaping each incident surface to condense light emitted from the LED onto the light emission surface of each light guide body is disclosed.

Moreover, a vehicle lamp disclosed in Patent Document 2 includes a plurality of LEDs arranged in an array and a light guide body provided in a direction in which the LEDs are arrayed. The light guide body includes a plurality of rear-surface projections provided on a side facing the LEDs, a plurality of front-surface projections provided in correspondence with the rear-surface projections, and a base portion 22 connecting them and light emitted from the plurality of LEDs is input and guided from an incident surface provided on each of the plurality of rear-surface projections and is emitted from a plurality of surfaces that are continuous in a circumferential direction of opposite-side front-surface projections. Moreover, some light is also emitted from the base portion between the front-surface projections. The front-surface protrusions have a polyhedral structure and multiple reflections caused by these polyhedrons create a gem-like brilliance and three-dimensional surface light emission. Moreover, technology in which the gem-like brilliance can be enhanced by arranging two front-surface protrusions for each light source so that regular and uniform light emission can be achieved with a smaller number of light sources, compared with when the LEDs, which are light sources, and the rear-surface projections are arranged in the one-to-one correspondence in a state in which the number of LEDs and the number of rear-surface projections are the same is disclosed.

### CITATION LIST

### Patent Document

Patent Document 1: Japanese Unexamined Patent Application, First Publication No. 2015-207476

Patent Document 2: Japanese Unexamined Patent Application, First Publication No. 2016-062844

### SUMMARY OF INVENTION

### Technical Problem

In an LED signal lamp described in the above Patent Document 1 and the like, light loss within each light guide body can be suppressed because cuts are formed on incident surfaces of plate-shaped light guide bodies so that a light distribution for condensing light emitted from the incident surfaces onto light emission surfaces located at positions facing the incident surfaces of the light guide bodies is controlled. However, because each cut provided on the incident surface is required to be formed so that the light is condensed to travel straight inside each light guide body toward the light emission surface, the incident surface and the light emission surface of each light guide body are required to be connected linearly. Therefore, there is a problem because each LED and each light guide body are required to be positioned in a predetermined relationship to make an array so that a light emission surface for emitting bright light is obtained and a degree of freedom in the design of a vehicle lamp is limited. Moreover, when the number of LEDs is increased to make the light emission surface brighter, because an incident angle of light incident on each light guide body differs, it is difficult to brighten the light emission surface by simply increasing the number of LEDs.

In the vehicle lamp described in the above Patent Document 2, front-surface projections have a polyhedral structure, and a gem-like brilliance and surface light emission with a three-dimensional appearance can be implemented by performing multiple reflections with the polyhedron. However, a three-dimensional appearance can be obtained, but the entire surface of the light emission surface side of the light guide body emits light. There is a problem because it is difficult to make the light emission at the distal end of the front-surface projection more prominent.

An aspect of the present invention is to provide a vehicle lamp that includes a light source and a light guide body and can increase a degree of freedom in the design of a three-dimensional shape of the vehicle lamp, allow a plurality of light output portions to be arrayed, and enhance the contrast between the plurality of light output portions. Moreover, a vehicle lamp that can improve the efficiency of light utilization is provided.

### Solution to Problem

An aspect of the present invention provides the above-described vehicle lamp by devising a configuration of a first light guide portion and a second light guide portion.

An aspect of the present invention is [1] a vehicle lamp including a light source and a light guide body configured to guide light emitted from the light source toward a side in front of the vehicle lamp,
wherein the light guide body includes a first light guide portion having a semicircular shape centered on a light-emitting portion of the light source and a second light guide portion arranged at a position farther away from the light-emitting portion than the first light guide portion,
wherein the first light guide portion has a first light-input-side side surface that is positioned away from the light-emitting portion and that is based on an arc centered on the light-emitting portion on which diffused light emitted from the light-emitting portion enters, and a first light-output-side side surface that is positioned on an opposite side of the first light-input-side side surface and that is based on an arc concentric with the arc of the first light-input-side side surface, the first light-output-side side surface including a first light output surface from which light entered from the first light-input-side side surface and being guided inside the first light guide portion is output,
wherein the second light guide portion has a second light-input-side side surface that is facing the first light-output-side side surface and that is based on an arc concentric with the arc of the first light-input-side side surface, a second light-output-side side surface that is formed on an opposite side of the second light-input-side side surface and that is substantially parallel to the first light-output-side side surface, and a plurality of light guide paths that project in a direction farther away from the light-emitting portion than the second light-output-side side surface and that have light-emitting portions in a distal end region,
wherein the plurality of light guide paths are aligned and arranged so that their light-emitting portions are spaced apart in a first direction,
wherein a second light input surface for inputting light output from the first light output surface into the second light guide portion is formed on the second light-input-side side surface corresponding to a proximal-end portion of each of the plurality of light guide paths, and
wherein a first light output surface is a refractive surface for condensing light from the light source input from the first light-input-side side surface toward the second light input surface and is formed at a position facing and corresponding to each of second light input surfaces, and each second light input surface becomes a substantially flat surface orthogonal with respect to a central axis of light output from the first light output portion.

According to the above-described invention, the light emission surface can be formed in a three-dimensional shape, thereby increasing the degree of freedom in the design of the vehicle lamp. Moreover, a light source using a plurality of LED elements can be employed and the intensity of light emitted from the light emission surface can be increased. Furthermore, it is possible to obtain a light emission surface with a plurality of bright light-emitting portions and a light-dark contrast between the light-emitting portions. Thereby, the visibility of the vehicle lamp can be further improved. Moreover, because there is a high degree of freedom in the size of the light source and in the alignment of the light source for the light guide body, problems are less likely to occur in a process for manufacturing vehicle lamps, which can contribute to reducing the costs of vehicle lamps.

Another aspect according to the present invention is [2] the vehicle lamp according to [1], wherein the first light guide portion and the second light guide portion are connected on a flat surface orthogonal to the first direction, and wherein an air layer is provided between the first light output surface of the first light guide portion and the second light-input-side side surface of the second light guide portion.

Yet another aspect according to the present invention is [3] the vehicle lamp according to [2], wherein the light source is a socket-type light-emitting diode (LED) lamp including a plurality of LED elements.

Yet another aspect according to the present invention is [4] the vehicle lamp according to [3], wherein the first light-input-side side surface of the first light guide portion is a toroidal surface.

Yet another aspect according to the present invention is [5] the vehicle lamp according to any one of [1] to [4], wherein the light-emitting portion of the second light guide portion outputs light from the light source within an irradiation range defined by a light distribution standard of a turn lamp when the light source is turned on.

According to each of the above-described other aspects, [2] because the air layer is provided, weight reduction can be further improved compared with when a resin layer is provided instead of the air layer. [3] Because the light source serves as the socket-type LED lamp, it is possible to provide the vehicle lamp in which the light source is easily replaced. Moreover, because the socket-type LED lamp includes a plurality of LED elements, a brighter vehicle lamp can be provided compared with when a single LED element is used as the light guide body. [4] Because the first light-input-side side surface is the toroidal surface, light loss when light is introduced into the light guide body can be reduced. [5] A vehicle lamp suitable for the turn lamp can be obtained.

### Advantageous Effects of Invention

According to the above-described configuration, it is possible to obtain a light emission surface with a high light-dark contrast between the light-emitting portion and the non-light-emitting portion that is darker than the light-emitting portion, while suppressing an increase in costs. Moreover, light emitted from the light source can be efficiently utilized and a degree of tolerance for the relative positional accuracy between the light source and the light guide body can be increased. Moreover, there is an advantage because a vehicle lamp with improved light utilization efficiency can be provided.

### BRIEF DESCRIPTION OF DRAWINGS

FIG. 1 is a top view showing an automobile equipped with a vehicle lamp according to an embodiment.

FIG. 2 is a front view showing a rear lamp, i.e., a view seen from a rear side in an irradiation direction.

FIG. 3 is a schematic top view showing a part of the rear lamp of FIG. 2 in a state in which some lamp assemblies are omitted.

FIG. 4 is a top view showing a basic configuration of a turn lamp assembly, which represents a main part of the vehicle lamp according to the present invention.

FIG. 5 is a sectional view taken along a horizontal flat surface in a left-right direction of the main part for describing light from a light source input to a light guide body.

FIG. 6 is an explanatory enlarged perspective view of a part of FIG. 5.

FIG. 7 is an explanatory schematic perspective view of a relationship between a light source and a first light guide portion.

FIG. 8 is an explanatory schematic sectional view of light rays input to the light guide body from the light source and a sectional view in an up-down direction orthogonal to the sectional view in the left-right direction of FIG. 5.

FIG. 9A is an explanatory schematic front view of a lighting state of a light emission surface and an explanatory view showing a non-lighting state.

FIG. 9B is an explanatory schematic front view of a lighting state of a light emission surface and an explanatory view showing a lighting state.

FIG. 10 is an explanatory schematic front view of a light-emitting portion of a socket-type LED lamp.

FIG. 11A is a plan view showing main parts of a light source for use in a vehicle lamp of a second embodiment.

FIG. 11B is a sectional view of the main parts of the light source for use in the second embodiment taken along line XIB-XIB shown FIG. 11A.

FIG. 12 is a plan view showing main parts of a light guide body for use in a vehicle lamp of a third embodiment.

FIG. 13 is a plan view showing main parts of a light guide body for use in a vehicle lamp of a fourth embodiment.

### DESCRIPTION OF EMBODIMENTS

Hereinafter, preferred embodiments of a vehicle lamp according to the present invention will be described with reference to the drawings.

### First Embodiment

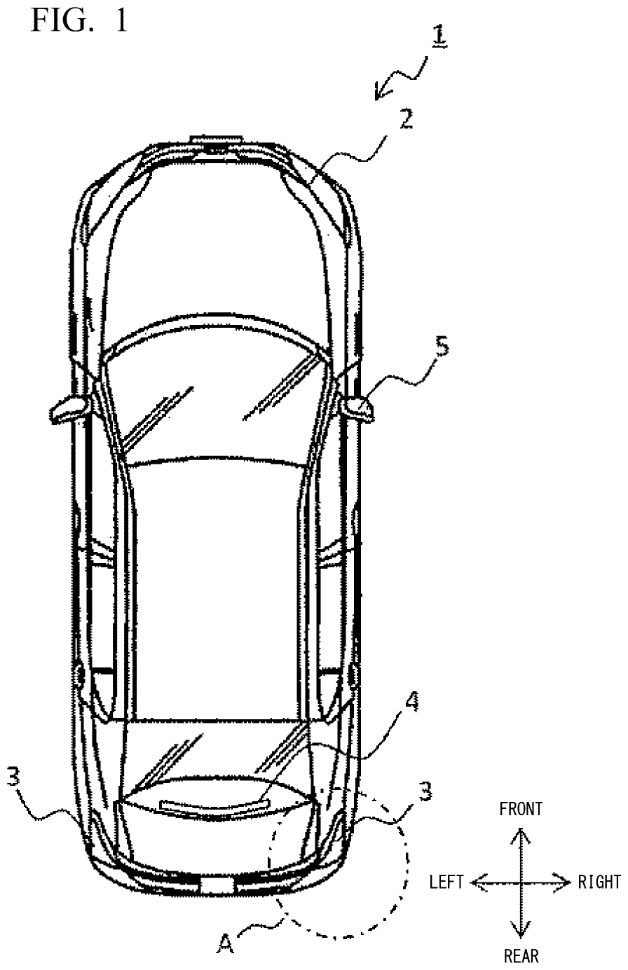

FIG. 1 is a top view showing an automobile 1 equipped with a vehicle lamp of an embodiment. The automobile is equipped with a plurality of vehicle lamps that emit light toward an outside of a vehicle for illumination or signaling. For example, headlamps 2 are provided at both front corners in a travel direction, rear lamps 3 are provided at both rear corners, and a high-mounted stop lamp 4 is provided at the center of a rear window area of the vehicle. Moreover, door mirror turn lamps 5 for direction indication are provided on the left and right door mirrors. Each lamp has one or more lamp assemblies inside. In addition, a type and size of the automobile are not limited to any particular type, and the vehicle lamps may be mounted on various types of vehicles such as passenger cars, commercial vehicles, buses, and trucks.

In the following description, unless otherwise specified, it is assumed that the terms “front,” “rear,” “left,” “right,” “up,” and “down” refer to the directions as seen from a driver when the vehicle lamp is installed on the automobile. Accordingly, “front” corresponds to a front direction of the vehicle (a travel direction of the automobile), which is a direction in which light from the headlamp 2 is emitted, “rear” corresponds to a rear direction of the vehicle (a direction behind the driver) in which light from a rear lamp 3 and the high-mounted stop lamp 4 is emitted, and “left” corresponds to a left side of the vehicle when viewed in the travel direction. “Down” corresponds to a road surface side (the driver's foot side).

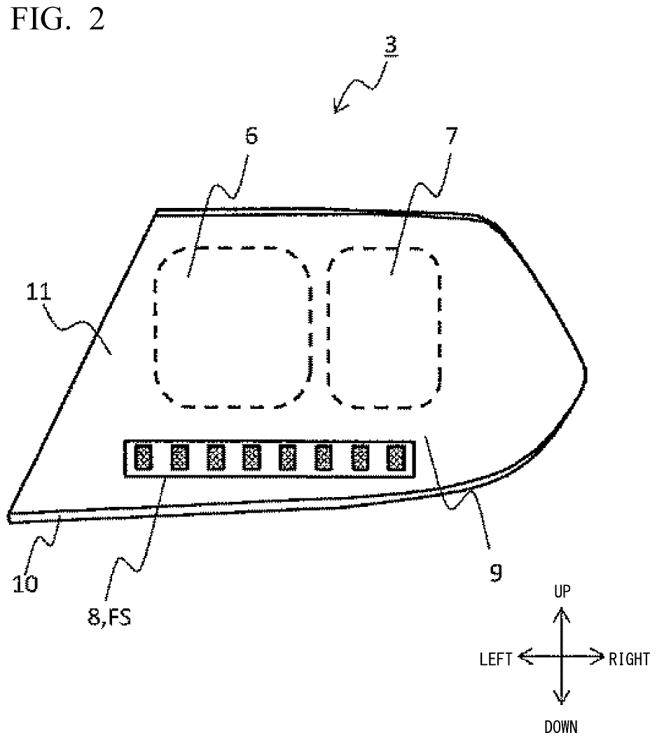

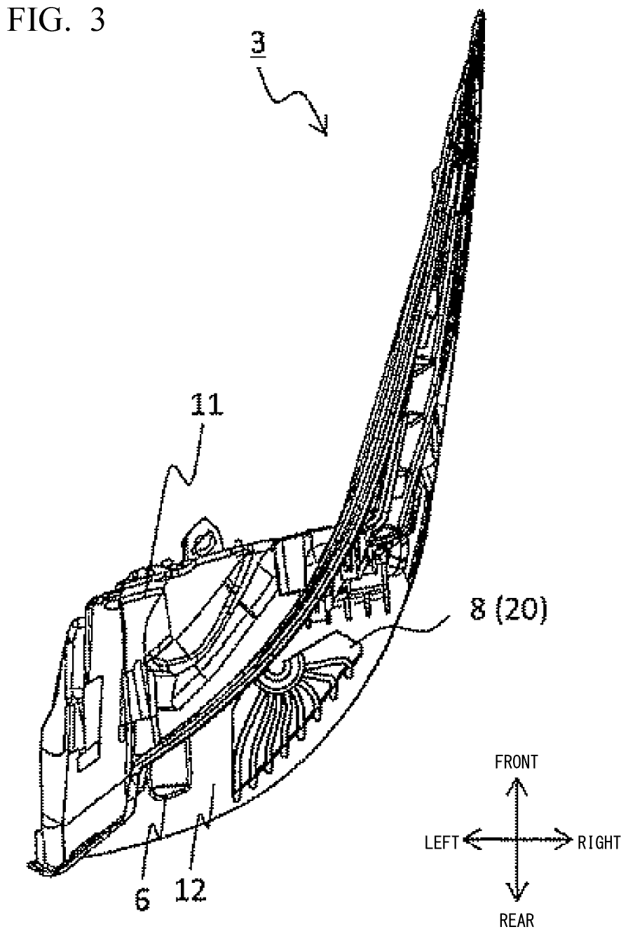

FIG. 2 is a front view showing the rear lamp 3, i.e., a view seen from the rear side, which is an irradiation direction. FIG. 3 is a top view showing a part of the rear lamp 3 of FIG. 2 in a state in which some lamp assemblies are omitted. The rear lamp 3 shown in FIGS. 2 and 3 represents a vehicle lamp provided at the right rear corner portion indicated by area A in FIG. 1. As shown in FIG. 3, the rear lamp 3 includes a housing 10 that opens toward the rear side and forms an internal space accommodating a plurality of lamp assemblies and an outer lens 11 that covers an opening of the housing 10 and forms a lamp accommodation portion 12 for accommodating the lamp assemblies. The outer lens 11 is watertightly fixed to a sealing portion provided on a peripheral edge of the housing 10 using a sealing member (not shown). The outer lens 11 is a transparent cover and is formed of a resin material such as polycarbonate, which exhibits excellent transparency, impact resistance, and weather resistance. In the outer lens 11, a refractive element for refracting irradiation light may be partially provided.

As shown in FIG. 2, the lamp accommodation portion 12 accommodates a plurality of lamp assemblies. In the present embodiment, reference sign 6 denotes a tail lamp, reference sign 7 denotes a tail-and-stop lamp, and reference sign 8 denotes a lamp assembly of a turn lamp. In FIG. 3, the tail-and-stop lamp 7 and the like are omitted and simplified for ease of understanding a configuration of the turn lamp assembly. The tail lamp assembly 6, the tail-and-stop lamp assembly 7, and the turn lamp assembly 8 emit light having predetermined light distribution patterns according to their functions toward the outside of the vehicle through the outer lens 11. The vehicle lamp may include a single lamp assembly or may include a plurality of lamp assemblies provided in the same housing. In the following description, the turn lamp assembly will be referred to simply as a “turn lamp.” The lamp accommodation portion 12 includes openings corresponding to the lamp assemblies provided inside and an extension 9 is arranged to cover the housing 11 and the like so that they cannot be seen from the outside.

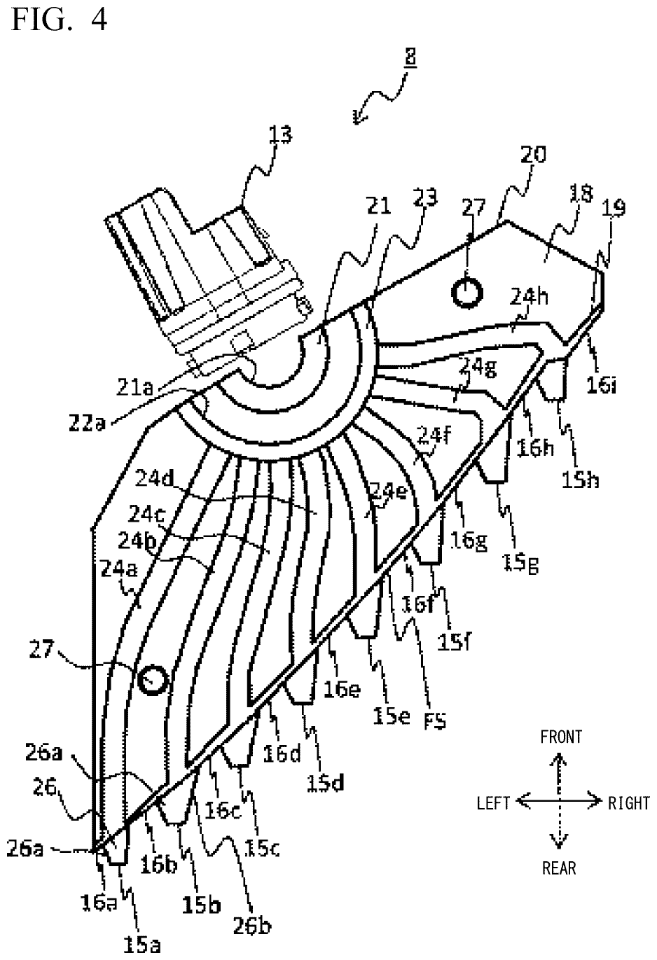

FIG. 4 is a top view showing a basic configuration of the turn lamp 8. The turn lamp 8 corresponds to the vehicle lamp according to the present invention. The turn lamp 8 includes a light source 13 and a light guide body 20 that receives light from the light source 13 and emits the light toward the outside of the vehicle from a light emission surface 14. The light source 13 and the light guide body 20 are fixed to the housing 10. In FIG. 4, only main parts necessary for describing an optical function of the turn lamp 8 are shown and the housing 10 is omitted. The light source 13 is also omitted from the illustration in FIG. 4. The light guide body 20 is made of a light-transmissive resin through which light emitted from the light source 13 can pass.

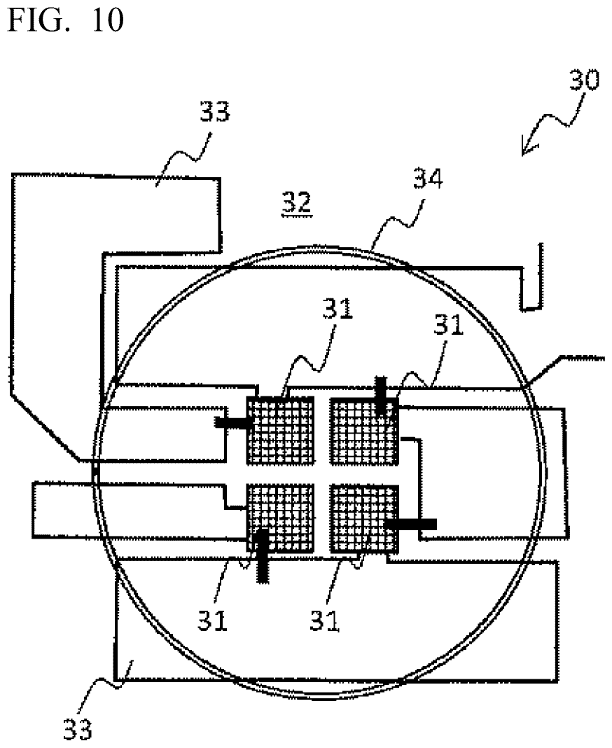

As shown in FIG. 2, the turn lamp assembly 8 forms a design in which the light emission surface 14 is long in a lateral direction in front view. The light emission surface 14 corresponds to one of the side end surfaces of the light guide body 20, which is substantially plate-shaped as a whole. As shown in FIGS. 2 and 10, the light emission surface 14 includes eight light-emitting portions 15 (15a to 15h) in a lateral direction and nine non-light-emitting portions 16 (16a to 16i) alternately arranged in the left-right direction (horizontal direction). When the light source 13 is turned on, light is emitted from the eight light-emitting portions 15a to 15h in a rear direction and a diagonal lateral direction. As a vehicle lamp provided at the rear corner of the vehicle, the turn lamp 8 emits light having a light distribution pattern that satisfies a required light distribution standard. Specifically, for example, the light emission surface 14 is inclined as a whole to have a side portion positioned in a front direction obliquely from the rear to the side of the vehicle so that a turn lamp signal light reaches in a range of 45° for the rear-side inner side of the vehicle and in a range of 80° for the rear-side surface side of the vehicle while using a reference axis of a driving direction (front-rear direction) of the vehicle as the center.

The light guide body 20 includes a first light guide portion 21 having a semi-annular shape centered around a light-emitting portion 30 of the light source 13, and a second light guide portion 22 arranged at a position farther away from the light source 13 than the first light guide portion 21. The second light guide portion 22 includes the light emission surface 14. Moreover, the first and second light guide portions 21 and 22 are connected and integrated by a first connection portion 17. The second light guide portion 22 includes a plurality of light guide paths 23 extending in a direction opposite to the light source 13, and distal end regions of the plurality of light guide paths 23 form the light-emitting portions 15 (15a to 15h). The light source 13 will be described below.

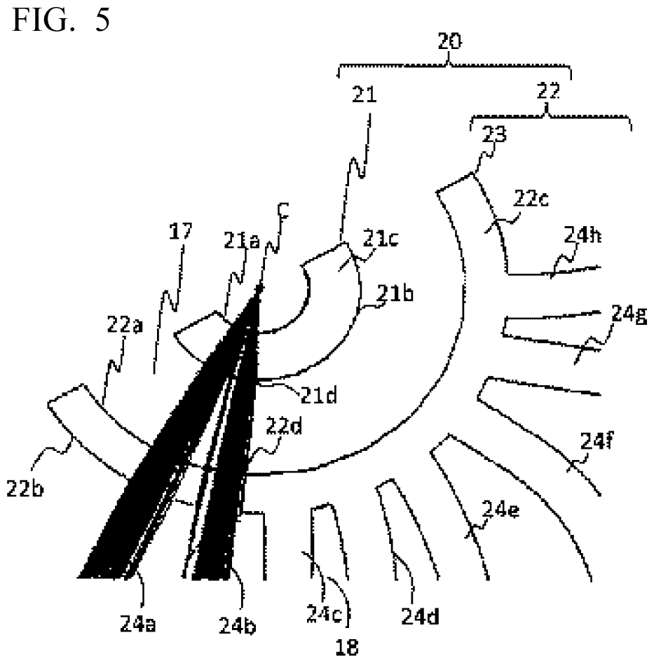

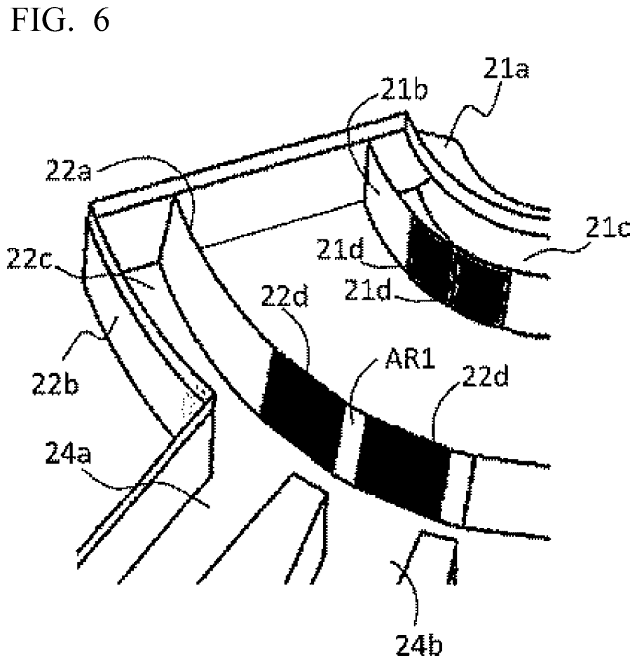

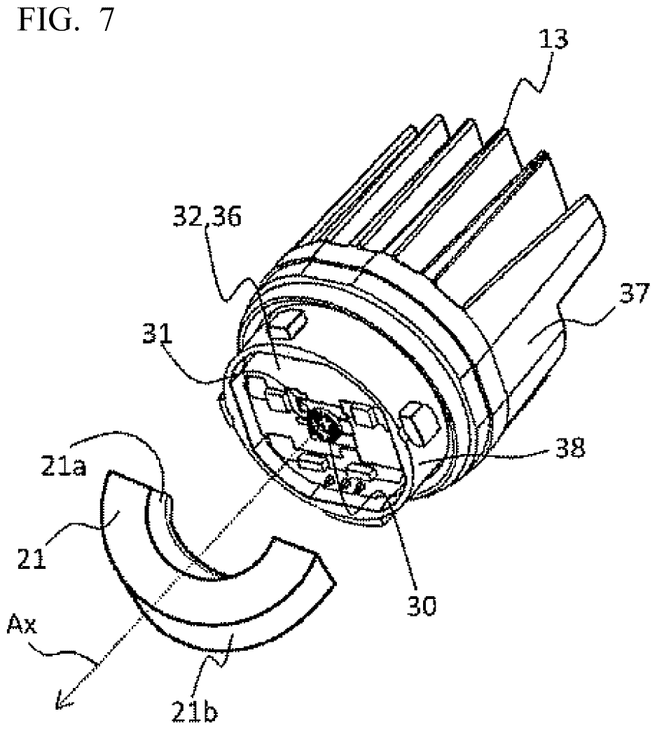

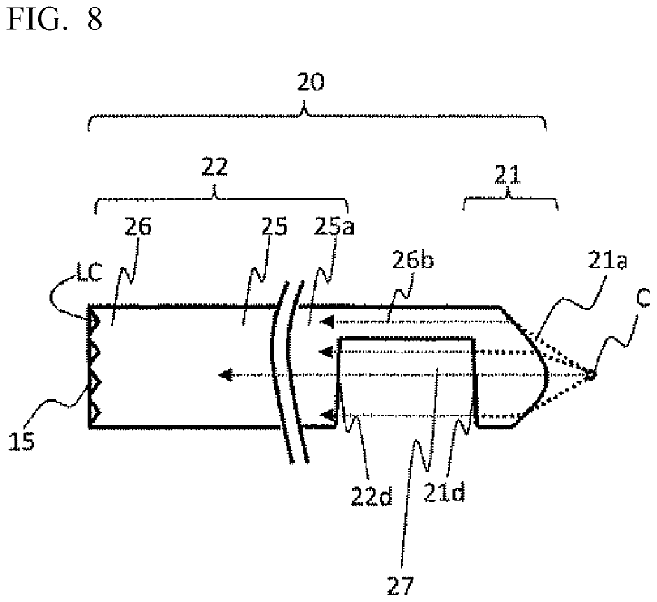

FIG. 5 is a sectional view taken along a horizontal flat surface in the left-right direction of the main part for describing an optical path of light from the light source 13 input to the light guide body 20. FIG. 6 is an explanatory enlarged perspective view of a part of FIG. 5. FIG. 7 is an explanatory schematic perspective view of a relationship between the light source 13 and the first light guide portion 21. FIG. 8 is an explanatory schematic sectional view of light rays input to the light guide body 20 from the light source 13 and is a sectional view in an up-down direction orthogonal to the sectional view in the left-right direction of FIG. 5.

The first light guide portion 21 includes a first light-input-side side surface 21a that is positioned apart from the light-emitting portion 30 and that is configured to input light emitted from the light-emitting portion to the light guide body 20, a first light-output-side side surface 21b that is positioned on an opposite side of the first light-input-side side surface 21a and that has a shape similar to that of the first light-input-side side surface 21a in a cross-section taken in the left-right direction centered on the light source 13, and a resin material layer 21c configured to fill a space between the first light-input-side side surface 21a and the first light-output-side side surface 21b.

The first light-input-side side surface 21a has different sectional shapes in the up-down direction and the left-right direction. Specifically, the first light-input-side side surface 21a is formed as a toroidal surface. In the cross-section taken in the left-right direction, as shown in FIG. 5, it is formed so that the sectional shape of the horizontal direction becomes an arc shape in correspondence with the light that diffuses in a radiation state in the left-right direction around an optical axis Ax of the light emitted from the light source. Thereby, it is possible to efficiently input light to be input from the first light-input-side side surface 21a to the first light guide portion 21. Accordingly, in the top view, the first light guide portion 21 has a partially open ring shape centered on the light-emitting portion 30 of the light source 13. In the cross-section taken in the up-down direction, as shown in FIG. 8, it is formed so that the sectional shape of the up-down direction becomes a convex arc shape centered on a position passing through the optical axis Ax in correspondence with the light that diffuses in a radiation state in the up-down direction around an optical axis Ax of the light emitted from the light source. By forming the convex shape toward the light source, the light emitted from the light source center C is input to the resin material layer 21c from the first light-input-side side surface 21 and is refracted into parallel light rays along the optical axis Ax and guided therein. In addition, the light source center C refers to the center of the light-emitting portion, and the term “parallel light rays” does not mean strictly parallel light rays; the sectional shape of the up-down direction may be a refractive surface for condensing light so that light can be regarded as parallel light rays.

The first light-output-side side surface 21b forms the shape of a cylindrical side surface centered on the light source center C. That is, in a sectional view along a flat surface extending through the light source center C in the left-right direction, an arc shape centered on the light source C is formed as shown in FIGS. 5 and 7. In the cross-section of a flat surface extending in the up-down direction through the light source center C, a straight-line shape extending in the up-down direction is formed as shown in FIG. 8. Thereby, light input from the first light-input-side side surface 21a and diffused in the left-right direction is output from the first light-output-side side surface 21b while its travel direction is maintained as shown in FIG. 8. On the other hand, light input from the first light-input-side side surface 21a and diffused in the up-down direction is output from the first light-output-side side surface 21b so that the light is refracted into light traveling in an approximately horizontal direction by the first light-input-side side surface 21a and travels straight in an approximately horizontal direction. Thus, it is possible to reduce the loss of light input from the first light-input-side side surface 21a, reduce light reflected on an inner surface inside the resin material layer 21c in the first light guide portion 21, and reduce the number of light components reflected on the inner surface by the first light-output-side side surface 21b. That is, it is possible to suppress the loss of light emitted from the light source 13 and convert the light in one direction, i.e., the up-down direction in the present embodiment, into parallel light rays.

As shown in FIGS. 4 and 5, the second light guide portion 22 includes a second light-input-side side surface 22a positioned facing the first light-output-side side surface 21b and a second light-input-side side surface 22b that is formed on the opposite side of the second light-input-side side surface 22a and that has a vertical sectional shape approximately parallel to the first light-output-side side surface 21b, and the second light guide portion 22 has a base portion 23 with a resin material layer 22c filling a space between the second light-input-side side surface 22a and the second light-input-side side surface 22b. Furthermore, a plurality of light guide paths 24 projecting from the base portion 23 are provided.

In the top view, the base portion 23 has a shape similar to that of the first light guide portion 21. That is, a partially open ring shape centered on the light-emitting portion 30 is formed as a whole. Therefore, the first light-input-side side surface 21a, the first light-output-side side surface 21b, and the second light-input-side side surface 22a are formed in arc shapes based on concentric circles centered on the light source center C in the cross-section of the flat surface extending in the left-right direction. The term “arc shapes based on concentric circles” is not limited to perfect arc shapes and also includes arc shapes along approximate curves that can be approximated to an arc shape of the concentric circle.

Moreover, the plurality of light guide paths 24 projecting from the base portion 23 include eight light guide paths 24a to 24h as shown in FIG. 4 in the present embodiment. Each of the light guide paths 24a to 24h has a length varying with a distance between the light emission surface 14 and the light source 13 as shown in FIG. 4. Moreover, a light guide path body portion 25 having a substantially rectangular shape in the cross-section taken in the up-down direction and a distal-end portion 26 are provided. Each light guide path body portion 25 of the light guide path is formed in a rectangular column shape extending from a proximal-end portion 25a on the base portion 23 side toward the distal-end portion 26 along a straight line and/or a curved line of a rectangular cross-section with approximately the same width. Each distal-end portion 26 includes an enlarged-diameter portion 26a larger than the light guide path body portion 25, a light-emitting portion 15 smaller than the enlarged-diameter portion 26a, and a connection surface 26b connecting the enlarged-diameter portion 26a and the light-emitting portion 15 as shown in FIG. 4.

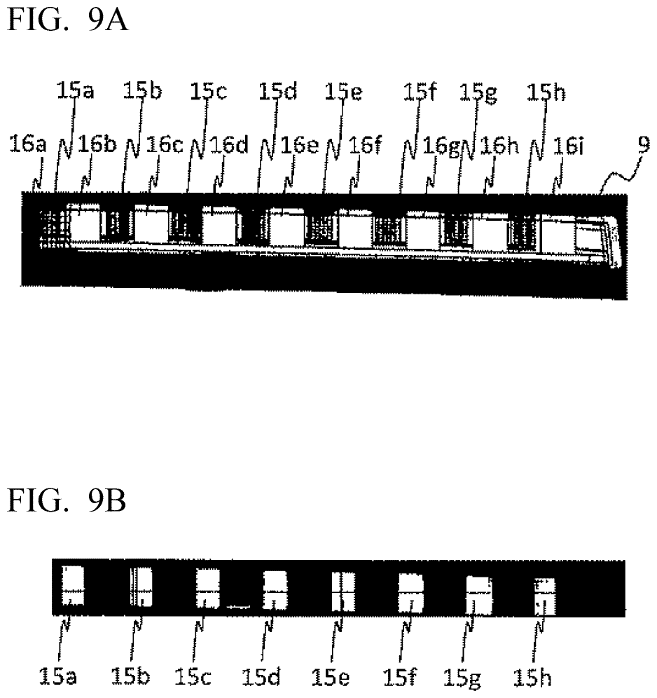

FIGS. 9A and 9B are explanatory schematic front views of the lighting state of the light emission surface 14. FIG. 9A is an explanatory view showing the non-lighting state and FIG. 9B is an explanatory view showing the lighting state. Each drawing shows a state when the turn ramp 8 is observed from the direction of the reference axis of the vehicle driving direction (front-rear direction). FIG. 9B is a simulation view of the lighting state and white regions are the light-emitting portions 15 (15a to 15h). In FIG. 9A, regions indicated by grid lines are the light-emitting portions 15 (15a to 15h), and white blank regions therebetween indicate the non-light-emitting portions 16 (16a to 16i). In addition, the grid lines indicating the light-emitting portions 15 (15a to 15h) indicate grid-shaped lens cuts formed on the surfaces of the light-emitting portions and the periphery of the light emission surface 14 is covered by the extension 9. The plurality of light guide paths 24 are aligned, formed, and spaced apart in the left-right direction so that the plurality of light-emitting portions 15 (15a to 15h) are alternately aligned with the non-light-emitting portions 16 (16a to 16i). A direction in which the plurality of light-emitting portions 15 (15a to 15h) are aligned and arrayed corresponds to the first direction in the present invention.

The light reaching each of the light-emitting portions 15a to 15h from the light source 13 is light passing through the first light guide portion 21 and input to the second light guide portion 22. In the present embodiment, second light input surfaces 22d are formed at positions corresponding to the proximal-end portions 25a on the second light-input-side side surface 22a of the second light guide portion 22 so that the light is efficiently input to the proximal-end portions 25a of the light guide paths 24a to 24h. Eight second light input surfaces 22d are formed in correspondence with the eight light guide paths 24a to 24h. Likewise, first light output portions 21d are formed at positions corresponding to the second light input surfaces 22d on the first light-output-side side surface 21b of the first light guide portion 21 so that light is efficiently guided toward each second light input surface 22d. Eight first light output portions 21d are formed in correspondence with the eight light guide paths 24a to 24h. As shown in FIG. 8, the first light output portions 21d and the second light input surfaces 22d are formed as parallel flat surfaces so that they are parallel. By making the flat surfaces parallel to each other, light output from the first light output portions 21d can be efficiently input from the second light input surfaces 22d. As shown in FIG. 8, in the cross-section taken in the up-down direction, because the first light output portion 21d and the second light input surface 22d are parallel, and the light output from the first light output portion 21d is light converted into parallel light on the first light-input-side side surface 21a, the light travels in parallel inside the air layer 27 between the first light output portion 21d and the second light input surface 22d. In the cross-section taken in the left-right direction, because the first light output portion 21d and the second light input surface 22d are parallel and the light output from the first light output portions 21d is light traveling in a state in which the light radiated from the light-emitting portion 30 of the light source 13 is radiated as it is, the light travels in the same diffusion direction inside the air layer 27 between the first light output portion 21d and the second light input surface 22d. Therefore, because reflection loss can be reduced in both the up-down direction and the left-right direction, the light can be input into the second light guide portion in a state in which the loss of an amount of light output from the light source 13 is suppressed and the light can be guided to the eight light guide paths 24a to 24h. The first light output portion 21d and the second light input surface 22d are not limited to the flat surfaces and may be cylindrical surfaces with straight lines extending in the up-down direction or may be polyhedral shapes based on a cylindrical surface. Although the first light output portions 21d and the second light input surfaces 22d are parallel in the cross-section taken in the up-down direction, the mold may be slightly inclined in consideration of the draft angle of the mold in the portion that forms the region of the air layer 27 when molding is performed using a mold. FIG. 8 shows an example with a slight inclination.

The size of each second light input surface 22d is a size of a range enclosed by an intersection line between a virtual flat surface obtained by extending the light guide path body portion 25 on the corresponding light guide path 24a to 24h toward the light source 13 side and the second light-input-side side surface 22a. As shown in FIG. 6, the second light input surface 22d corresponding to the light guide path 24a and the second light input surface 22d corresponding to the light guide path 24b are shaded in gray. As can be seen from FIG. 6, a region AR1 of the second light-input-side side surface 22a where no second light input surface 22d is provided is also located between adjacent second light input surfaces 22d. As shown in FIG. 8, because the second light input surfaces 22d are provided on the corresponding light guide paths 24a to 24h, when any adjacent light guide paths among the light guide paths 24a to 24h are located close to each other, for example, when the proximal-end portion 25a of the light guide path 24a and the proximal-end portion 25a of the light guide path 24b are positioned close to each other so that they partially overlap each other, it is only necessary for the corresponding second light input surfaces 22d to be arranged to partially overlap each other. When they are arranged to partially overlap, the region AR1 shown in FIG. 6 is not formed. Because light reaching the region AR1 is light that is not actively input to any light guide path 24, it is preferable not to form such a region AR1 or to prevent light from being directed toward the region AR1. For example, when the shape of the first light-output-side side surface 21b is formed as an assembly of first light output portions 21d whose all surfaces output light toward a corresponding second light input surface 22d, the occurrence of light directed toward the region AR1 can be prevented.

In this way, each of the plurality of first light output portions 21d corresponding to the plurality of second light input surfaces 22d is formed as a refractive surface where light of the light source 13 that is input from the first light-input-side side surface 21a and that is converted into substantially parallel light rays is condensed toward the corresponding second light input surface 22d. Each second light input surface 22d is a substantially flat surface orthogonal to the central axis of light output from the first light output portion 21d. Thereby, it is possible to distribute light radiated from the light source 13 to the plurality of light guide paths 24 while minimizing the loss of the light.

Each of the plurality of light guide paths 24 (24a to 24h) projecting from the base portion 23 extends from the proximal-end portions 25a to the distal-end portion 26 so that there is no acute bending point. By extending along a straight line and/or a curved line without forming the acute bending point, it is possible to reduce internal surface reflection while the light is being guided inside each light guide path 24, thereby suppressing light loss.

End surfaces of the front sides of the distal-end portions 26 of the plurality of light guide paths 24 (24a to 24h) serve as light-emitting portions 15 (15a to 15h). By appropriately changing the lengths, sizes, and array directions of the plurality of light guide paths 24, light emission surfaces of various shapes can be obtained. The light guided inside each light guide path 24 to the light-emitting portion 15 preferably reaches the light-emitting portion 15 by traveling straight from the proximal-end portion 25a, but the light may be light passing through the light guide path 24 extending without a bending point in accordance with the lamp design. On each light guide path 24, when the proximal-end portion 25a and the light-emitting portion 15 are not positioned on a straight line, light that has undergone internal surface reflection inside the light guide path body portion 25 reaches the light-emitting portion 15. The light undergoing internal surface reflection may undergo a plurality of internal surface reflections according to a shape of the light guide path body portion 25. The number of internal surface reflections until the light reaches the light-emitting portion 15 may vary. Thus, the light that has undergone internal surface reflection is light traveling in a large number of directions compared to the light traveling straight from the proximal-end portion 25a to the light-emitting portion 15. Therefore, in the present embodiment, an enlarged-diameter portion 26a and a connection surface 26b are provided at the distal-end portion so that a light component reflected on the connection surface 26b and directed toward the light-emitting portion 15 is generated. Thereby, it is possible to expand the irradiation range of the light output from the light-emitting portion 15. Moreover, a large number of lens cuts LC are provided in the light-emitting portion to control a direction of refracted and output light. Thereby, a light distribution standard for a predetermined turn lamp is satisfied.

The plurality of light guide paths 24 (24a to 24h) are provided with air layers between adjacent light guide path body portions 25. As shown in FIG. 4, a boundary portion between the light guide path body portion 25 and the adjacent distal-end portion 26 of the light guide path 24 is connected by a third connection portion 19. A resin layer FS of this connection constitutes a part of the light emission surface 14. The light emission surface 14 is a region of a range recognized as one region having a light emission region of the turn lamp 8, and includes the non-light-emitting portions 16 (16a to 16i) and the light-emitting portions 15 (15a to 15h) when viewed from the front.

While air layers are provided between the adjacent light guide path body portions 25, the plurality of light guide paths 24 (24a to 24h) are integrated by providing a second connection portion 18 on the lower surface so that one continuous flat surface is formed thereby. In other words, the air layers arranged between the adjacent light guide path body portions 25 are recess portions between the light guide path body portions 25. By forming the lower surface as one continuous flat surface, mounting portions 27 for fixing to the housing 10 can be provided at positions that do not affect the emission of light guided within the light guide path body portion. For example, as shown in FIG. 4, two mounting portions 27 are provided as screw holes for fixing to the housing 10.

Moreover, the first light guide portion 21 and the second light guide portion 22 are also integrated on the lower side to form one continuous flat surface continued by the first connection portion 17 therebetween. Thereby, the light guide body 20 as a whole can be handled as a single plate-like component. Because air layers are provided between the first and second light guide portions 21 and 22 and between the adjacent light guide path body portions 25 of the plurality of light guide paths 24 (24a to 24h), it is also possible to reduce weight when the overall structure is made of a solid plate part.

Next, the light source 13 will be described.

In the present embodiment, an LED module composed of a socket-type LED lamp in which a plurality of orange-emitting LED elements 31, each of which is formed by laminating semiconductor layers, are mounted is used. The socket-type LED lamp is detachably mounted in a socket fixing hole (not shown) provided in the housing 10. Thereby, when the light source 13 fails, it can easily be replaced. The light guide body 20 is mounted and fixed to the housing 10 either directly or indirectly. When the light source 13 composed of the socket-type LED lamp is mounted in the socket fixing hole, the light-emitting portion 30 of the light source 13 is positioned at a predetermined position relative to the light guide body 20 fixed to the housing 10. FIG. 4 shows the light source 13 and the light guide body 20 arranged at their predetermined positions. In addition, the light source 13 is not limited to the socket-type LED lamp and a surface-mounted LED in which a plurality of light-emitting elements are arranged or other types of light sources may be used. The orange-light-emitting LED elements 31 are used to emit light having a light emission color that complies with the regulations for the turn lamp 8.

FIG. 7 is an explanatory schematic perspective view of a positional relationship between the light source 13 composed of the socket-type LED lamp of the present embodiment and the first light guide portion 21 of the light guide body 20. FIG. 10 is an enlarged plan view showing the light-emitting portion 30 of the socket-type LED lamp 13. For the socket-type LED lamp 13, a plurality of LED elements 31 are mounted on the front side of a circuit board 32 where a wiring pattern 33 is provided. A frame body 34 that reflects light emitted by the plurality of LED elements 31 in the front direction is provided on the front side of the circuit board 32. The frame body 34 is made of a cylindrical white member and is provided on the front side of the circuit board 32 so as to surround the periphery of the plurality of LED elements 31 while having the plurality of LED elements 31 as the center. A transparent sealing resin that seals the inner side of the frame body 34 is provided inside the frame body 34. The circuit board 32 is fixed to a board mounting portion 36 of a socket body 35. A heat sink 37 for externally dissipating heat generated by the LED elements 31 is provided at the rear side of the board mounting portion 36. Moreover, a connector portion electrically connected to the circuit board 32 via a plurality of lead terminals (not shown) is provided on a rear portion of the socket body 35. A socket portion 38 is provided at a position of the board mounting portion 36 in a circumferential direction in the socket body 35 and the socket portion 38 detachably engages with a socket fixing hole of the housing 10 (not shown).

FIG. 10 is an explanatory schematic front view of the light-emitting portion 30 of the socket-type LED lamp. An inside region of the frame body 34 serves as the light-emitting portion 30. Each of the plurality of LED elements 31 emits light having a Lambertian light distribution characteristic. In the Lambertian light distribution, light is emitted directionally about an optical axis direction (a direction perpendicular to the light emission surface of the LED element), and becomes light emitted in a direction in which an angle of a half value of an intensity of light on the optical axis is 60° when the optical axis is the center. In this way, each LED element 31 has directivity. The frame body 34 reflects a part of a light component emitted from the LED element 31. Although the intensity of the light reflected by the frame body 34 is less than or equal to half the intensity of light on the optical axis, the light emitted from the LED element 31 can be effectively used by using these light rays.

As a plurality of LED elements 31 positioned in the light-emitting portion 30, four LED elements 31 are arranged at the four vertices of a square in the present embodiment. The light emitted from the light-emitting portion 30 becomes composite light including direct light from the four LED elements 31 and reflected light from the frame body 34 and the like. The above-described light source center C refers to the center point when the four LED elements are aligned and mounted, which also coincides with the center of the frame body 34.

When a size relative with respect to the light guide body 20 is considered, it is difficult to regard the light-emitting portion 30 as a point light source. Moreover, when a replaceable socket-type LED lamp 13 is used, the position accuracy between the LED elements 31 and the light guide body 20 becomes lower than when they are directly aligned. Thus, the light input to the light guide body 20 may be always not only input from the light source center C as shown in FIG. 5, but there is also a case the light input to the light guide body 20 travel toward the first light-input-side side surface 21a from a position offset from the vicinity of the light source center C. Moreover, because the light emitted from the light source center C is light from a given size range instead of light from a point light source as shown in FIG. 5 in practice, there are light components that travel from positions near the light source center C toward the first light-input-side side surface 21a and are guided inside the light guide body 20.

In the present embodiment, the first light-input-side side surface 21a is formed in an arc shape when the light source center C is a rotation center in the cross-section taken in the left-right direction. Therefore, light from the light source center C as well as light reaching the first light-input-side side surface 21a from its vicinity can be input while the light is spread radially in a state in which reflection on the first light-input-side side surface 21a is suppressed. Consequently, even if the light source 13 cannot be regarded as a point light source as described above, light can be efficiently condensed by the first light guide portion. Moreover, in the cross-section taken in the up-down direction, the central portion of the first light-input-side side surface 21a is formed in a projected convex shape for converting light into parallel light rays. Because light reaching the first light-input-side side surface 21a from a position near the light source center C also has the same effect in the cross-section taken in the up-down direction, the light travels to the second light guide portion 22 as substantially parallel light. Accordingly, even if a socket-type LED lamp 13 equipped with a plurality of LED elements is used as the light source 13, it is possible to input light to the first light guide portion 21 in a state in which the loss of radially emitted light is suppressed and guide the light to the second light guide portion 22 by suppressing the loss occurring in the first light guide portion 21. Moreover, when a socket-type LED lamp 13 equipped with a plurality of LED elements is used as the light source 13, it is possible to use a plurality of LED elements 31 as the light source and establish a multi-to-one or multi-to-multi relationship, compared with when there is a relationship, i.e., a one-to-one relationship, in which an LED light source using only one LED element 31 is provided for one light guide plate as in Patent Document 1. For example, although four LED elements are used in the present embodiment, it is possible to further increase brightness using five or more LED elements. Thereby, it is possible to easily increase an intensity of light emitted from the light emission surface 14 and increase an intensity of light output from the light-emitting portions 15 (15a to 15h) that are final light output regions. Moreover, even if a plurality of LED elements are used, because it is not necessary to individually set an assumed positional relationship between each LED element and the incidence portion of the light guide body, as in Patent Document 1, it is possible to increase a range of tolerance for variation in a vehicle lamp assembly, ultimately easily assemble vehicle lamps, and reduce the number of defective products.

According to the vehicle lamp of the present embodiment, light emitted from the light source 13 can be input to the light guide 21 from the light-emitting portions 15 (15a to 15h) arrayed at intervals with suppressed loss, and the light can be guided while being divided into the plurality of light guide paths 24 with little loss. Because the second light input surface 22d is provided so that light travels toward each light guide path 24, almost no light is directed toward the non-light-emitting portions 16 of the light-emitting portions 15 (15a to 15h). Accordingly, it is possible to obtain the light emission surface 14 with the high light-dark contrast between the light-emitting portions 15 and the non-light-emitting portions 16 and make the light-emitting portions 15 more prominent. Although all the light guide paths 24 are formed with the same width in the present embodiment, it is also possible to make the width of the light guide paths 24 positioned on or near the optical axis of the light source smaller, and make the width of the light guide path 24 positioned farther away larger, thereby equalizing the brightness distribution across the light emission surface 14 of the plurality of light-emitting portions 15.

### Second Embodiment

Next, a second embodiment will be described.

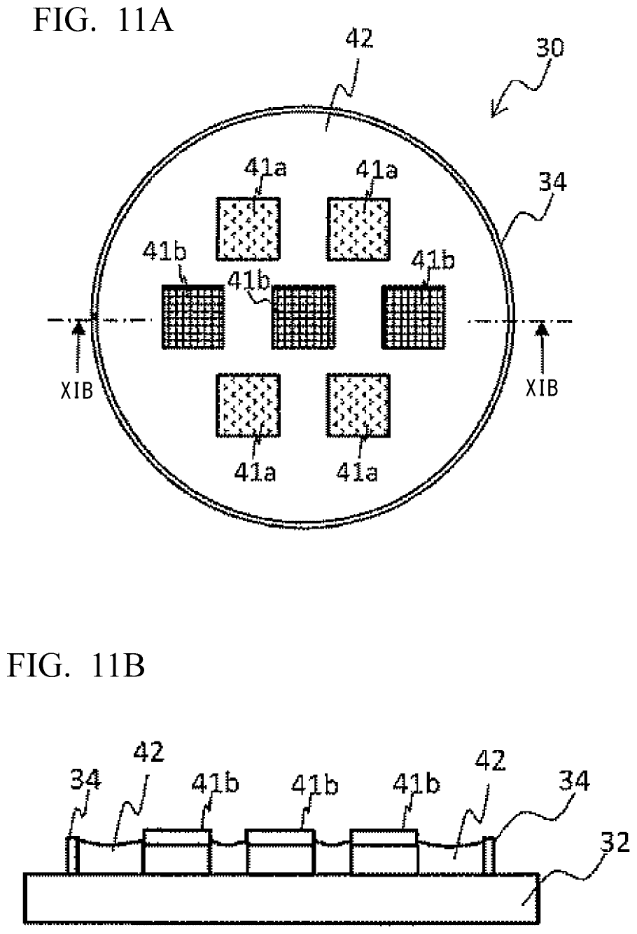

FIG. 11A is a plan view showing main parts of the light source 13 for use in the vehicle lamp of the second embodiment. FIG. 11B is a sectional view of the main parts of the light source for use in the vehicle lamp of the second embodiment taken along line XIB-XIB shown in FIG. 11A. The second embodiment uses the same light guide body 20 as the first embodiment. The first and second embodiments are also the same in that the light source 13 is a socket-type LED lamp. Unlike the first embodiment, the number of the LED elements arranged inside the frame body 34 of the socket-type LED lamp of the first embodiment or the like is different. The other configurations are identical to those of the first embodiment and will not be described here.

An inner region of the frame body 34 is the light-emitting portion 30, and four orange-light-emitting LED elements 31 are arranged in two rows x two columns as shown in FIG. 10 in the first embodiment. In the second embodiment, as shown in FIG. 11A, a total of seven LED elements 41 are arranged in three rows, wherein two LED elements are arranged in each of the first and third rows and three LED elements are arranged in the second row. Among these seven LED elements, the four LED elements 41a in the first and third rows are used to emit white light and the three LED elements 41b in the second row are used to emit orange light. The plurality of white-light-emitting LED elements 41a and the plurality of orange-light-emitting LED elements 41b are wired and controlled independently so that they can be switched on separately. Thereby, the socket-type LED lamp functions as a light source capable of emitting two colors. Moreover, as shown in FIG. 11A, white resin 42 is filled between the LED elements 41 and between the LED elements 41 and the frame body 34. As shown in FIG. 11B, the white resin 42 is formed to cover side surfaces of the LED elements 41 without covering their top surfaces. Thereby, light components emitted in directions perpendicular to the optical axis are reflected from the LED elements 41, thereby increasing the number of light components emitted in the optical axis direction.

In the second embodiment, switching between white light emission and orange light emission can be performed. A part that emits light within the light-emitting portion 30 is different between the four white-light-emitting LED elements 41a and the three orange-light-emitting LED elements 41b. Accordingly, the light distribution pattern of the light source directed toward the first light-input-side side surface 21a of the light guide body 20 is different three-dimensionally between the case of white light emission and the case of orange light emission. However, because the first light guide portion 21 and the base portion 23 of the second light guide portion are positioned on a concentric circle centered on the light source center C and the first light-input-side side surface 21a is formed as a toroidal surface in the second embodiment, light is radiated from a plurality of light-emitting portions 15 while suppressing loss of light emission of any color, and light components toward the non-light-emitting portions 16 between the light-emitting portions 15 can be suppressed so as to form the light emission surface 14 having a high light-dark contrast.

### Third Embodiment

Next, a third embodiment will be described.

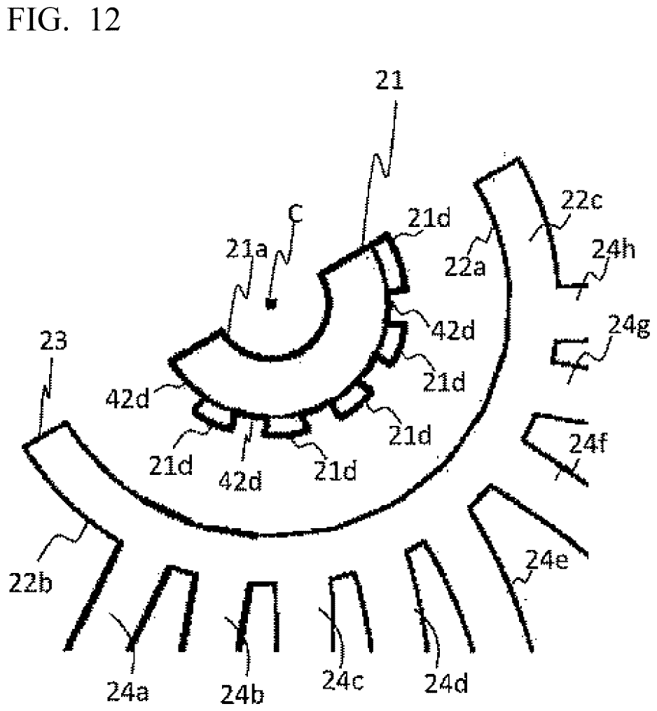

FIG. 12 is a plan view showing main parts of a light guide body for use in the vehicle lamp according to the third embodiment. The third embodiment uses the same light source 13 as the first embodiment. In the light guide body 20, the structure of the first light guide portion is different from that of the first embodiment and the structure of the second light guide portion 22 is the same as that of the first embodiment. Constituent elements identical to those of the first embodiment are denoted by the same reference signs and description thereof is omitted here.

As shown in FIG. 12, the first light guide portion 42 of the present embodiment includes: a first light-input-side side surface 21a configured to input light emitted from the light-emitting portion 30 centered on the light source center C to the light guide body 20; a first light-output-side side surface 42b positioned on an opposite side of the first light-input-side side surface 21a; and a resin material layer 21c configured to fill a space between the first light-input-side side surface 21a and the first light-output-side side surface 42b.

The first light-output-side side surface 42b forms a shape of a cylindrical surface centered on the light source center C as a whole. That is, in a cross-section taken along a flat surface extending in the left-right direction through the light source center C, a first light output portion 21d formed along an arc centered on the light source C is provided as shown in FIGS. 5 and 7. The first light output portion 21d is the same as that of the first embodiment and is formed at a position corresponding to the second light input surface 22d provided on the second light guide portion 22. The present embodiment is different from the first embodiment is that a recess portion 42c is provided between adjacent first light output portions 21d and/or at a position adjacent to the first light output portion 21d, in the present embodiment.

Light output from the light-emitting portions 15 (15a to 15h), which are the final light output portions of the light guide body 20, is light input into the light guide body 20 from the first light-input-side side surface 21a. Moreover, the light is a light component that has traveled through the light guide paths 24 (24a to 24h) corresponding to the light-emitting portions 15 (15a to 15h), the second light input surface 22d, and the first light output portion 21d.

To enhance the contrast between the light-emitting portions 15 (15a to 15h) and the non-light-emitting portions 16 (16a to 16i), it is preferable to suppress light traveling toward the light emission surface 14 without passing through the light guide paths 24 (24a to 24h). Accordingly, in the present embodiment, the recess portion 42c is formed as an inclined reflective surface, thereby reducing the amount of light passing through the recess portion 42c toward the second light-input-side side surface 22a. The recess portion 42c is a flat surface inclined in the cross-section taken in a direction orthogonal to the sheet plane of FIG. 12. Specifically, it is positioned on an arc centered on the same light source C as the first light output portion 21d at the upper side of the first light guide portion 42, and it is on the concentric circle with the arc which is centered on the same light source C as the first light output portion 21d at the lower side of the first light guide portion 42, but it is positioned on an arc of a smaller diameter in which the radius of the concentric circuit is reduced and is formed as a flat surface in which the different concentric circles are connected in the up-down direction. Thereby, a part of light reaching the recess portion 42c among light input from the first light-input-side side surface 21a is reflected obliquely upward since the recess portion 42c is made as the inclined reflective surface inclined in the up-down direction, while the other part of the light is refracted obliquely downward and output. Thereby, light directed toward the second light-input-side side surface 22a is reduced. In addition, when it is desired to make the non-light-emitting portions 16 (16a to 16i) emit light darker than the light-emitting portions 15 (15a to 15h) to create the light emission with a light-dark contrast without increasing the contrast between the light-emitting portions 15 (15a to 15h) and the non-light-emitting portions 16 (16a to 16i), it is only necessary for the recess portion 42c to be made into a diffusing surface with fine irregularities formed thereon instead of a reflective inclined surface.

### Fourth Embodiment

### Next, a Fourth Embodiment Will Be Described.

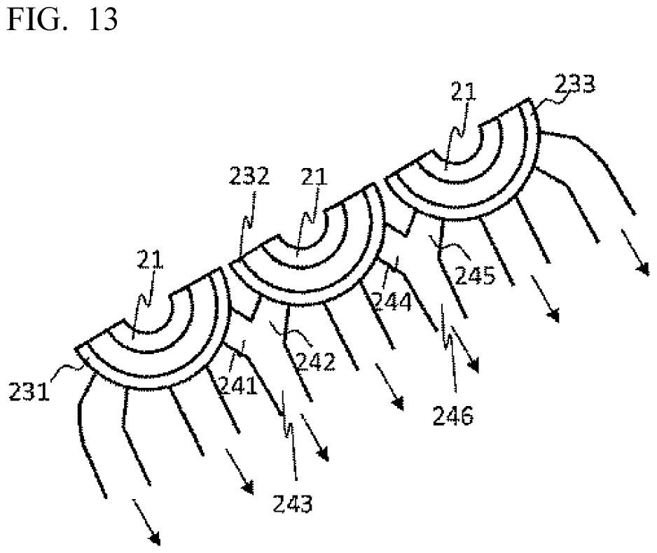

FIG. 13 is a plan view showing main parts of a light guide body for use in a vehicle lamp of the fourth embodiment. Constituent elements identical to those in the first embodiment are denoted by the same reference signs and descriptions thereof are omitted here. In the fourth embodiment, three light sources in FIG. 13 are used as a plurality of light sources 13 identical to those of the first embodiment. In the light guide body 43, three first light guide portions 21 corresponding to the three light sources 13 and three base portions 23 of second light guide portions corresponding to the first light guide portions are arranged. In the base portions 231, 232, and 233, three light guide paths 24 are extended for the base portions. The light guide paths 241 and 242 positioned between the base portions 231 and 232 adjacent to each other are joined together to form one light guide path 243 in which light emitted from the two light sources is combined. Likewise, the light guide paths 244 and 245 positioned between the base portions 232 and 233 adjacent to each other are joined together to form one light guide path 246 in which light emitted from the two light sources is combined. Accordingly, a brighter light-emitting portion 15 can be obtained. For example, it is also possible to accommodate cases where irradiation light brighter than that of a turn lamp, such as a daytime running lamp (DRL), is required.

Although the embodiments of the present invention have been described above, these embodiments are merely examples in all respects. The present invention should not be construed as being limited by the above descriptions. Various additions, omissions, substitutions, and other modifications of the configuration can be made without departing from the scope of the invention. For example, an extension having a window corresponding to the light-emitting portion 15 may be provided between the outer lens and the light guide body 20 to cover the light emission surface 14. Although an example of the application to the turn lamp 8 provided in the rear lamp mounted in the rear direction of the vehicle has been described, the present invention is not limited thereto. The turn lamp 8 described above may be provided in the headlamp 2 or the door mirror turn lamp 5 shown in FIG. 1. Moreover, the present invention is not limited to the turn lamp 8. For example, the present invention can also be applied to the high-mounted stop lamp 8 by setting the lighting color of the light source 13 to red.

### Industrial Applicability

The present invention can be applied to vehicle lamps for motorcycles such as motorbikes, motor scooters, and other similar vehicles or vehicles with interior spaces such as four-wheeled vehicles, trucks, and three-wheeled vehicles.

### REFERENCE SIGNS LIST

1 Automobile
2 Headlamp
3 Rear lamp
4 High-mounted stop lamp
5 Door mirror turn lamp
6 Tail lamp
7 Tail-and-stop lamp
8 Turn lamp
9 Extension
10 Housing
11 Outer lens
12 Lamp accommodation portion
13 Light source (socket-type LED lamp)
14 Light emission surface
15 (15a to 15h) Light-emitting portion
16 (16a to 16i) Non-light-emitting portion
17 First connection portion
18 Second connection portion
20, 43 Light guide body
21, 42 First light guide portion
22 Second light guide portion
21a First light-input-side side surface
21b, 42b First light-output-side side surface
21c Resin material layer
21d First light output portion
22a Second light-input-side side surface
22b Second light-output-side side surface
22c Resin material layer
22d Second light input surface
23, 231, 232, 233 Base portion
24 (24a to 24h) Light guide path
241, 242, 243, 244, 245, 246 Light guide path
25 Light guide path body portion
26 Distal-end portion
25a Proximal-end portion
26a Enlarged diameter portion
26b Connection surface
27 Mounting portion
30 Light-emitting portion
31, 41 LED element
32 Circuit board
33 Wiring pattern
34 Frame body
35 Socket body
36 Board mounting portion
37 Heat sink
38 Socket portion
42c Recess portion
C Light source center
Ax Optical axis
AR1 Region
LC Lens cut

1. A vehicle lamp including a light source and a light guide body configured to guide light emitted from the light source toward a side in front of the vehicle lamp,
wherein the light guide body includes a first light guide portion having a semicircular shape centered on a light-emitting portion of the light source and a second light guide portion arranged at a position farther away from the light-emitting portion than the first light guide portion,
wherein the first light guide portion has a first light-input-side side surface that is positioned away from the light-emitting portion and that is based on an arc centered on the light-emitting portion on which diffused light emitted from the light-emitting portion enters, and a first light-output-side side surface that is positioned on an opposite side of the first light-input-side side surface and that is based on an arc concentric with the arc of the first light-input-side side surface, the first light-output-side side surface including a first light output surface from which light entered from the first light-input-side side surface and being guided inside the first light guide portion is output,
wherein the second light guide portion has a second light-input-side side surface that is facing the first light-output-side side surface and that is based on an arc concentric with the arc of the first light-input-side side surface, a second light-output-side side surface that is formed on an opposite side of the second light-input-side side surface and that is substantially parallel to the first light-output-side side surface, and a plurality of light guide paths that project in a direction farther away from the light-emitting portion than the second light-output-side side surface and that have light-emitting portions in a distal end region,
wherein the plurality of light guide paths are aligned and arranged so that their light-emitting portions are spaced apart in a first direction,
wherein a second light input surface for inputting light output from the first light output surface to the second light guide portion is formed on the second light-input-side side surface corresponding to a proximal-end portion of each of the plurality of light guide paths,
wherein a first light output portion serving as a refractive surface for condensing light from the light source input from the first light-input-side side surface toward the second light input surface after being guided inside the first light guide portion as substantially parallel light rays is provided on the first light output surface corresponding to each of second light input surfaces, and
wherein each second light input surface becomes a substantially flat surface orthogonal to the substantially parallel light rays output from the first light output portion.

2. The vehicle lamp according to claim 1,
wherein the first light guide portion and the second light guide portion are connected on a flat surface orthogonal to the first direction, and
wherein an air layer is provided between the first light output surface of the first light guide portion and the second light-input-side side surface of the second light guide portion.

3. The vehicle lamp according to claim 2, wherein the light source is a socket-type light-emitting diode (LED) lamp including a plurality of LED elements.

4. The vehicle lamp according to claim 3, wherein the first light-input-side side surface of the first light guide portion is a toroidal surface.

5. The vehicle lamp according to claim 4, wherein the light-emitting portion of the second light guide portion outputs light from the light source within an irradiation range defined by a light distribution standard of a turn lamp from the light-emitting portion when the light source is turned on.

6. The vehicle lamp according to claim 3, wherein the light-emitting portion of the second light guide portion outputs light from the light source within an irradiation range defined by a light distribution standard of a turn lamp from the light-emitting portion when the light source is turned on.

7. The vehicle lamp according to claim 2, wherein the light-emitting portion of the second light guide portion outputs light from the light source within an irradiation range defined by a light distribution standard of a turn lamp from the light-emitting portion when the light source is turned on.

8. The vehicle lamp according to claim 1, wherein the light-emitting portion of the second light guide portion outputs light from the light source within an irradiation range defined by a light distribution standard of a turn lamp from the light-emitting portion when the light source is turned on.
